(19) United States
(12) Patent Application Publication
(10) Pub. No.: US 2018/0239813 A1
(43) Pub. Date: Aug. 23, 2018

(54) INFORMATION PROCESSING APPARATUS AND INFORMATION PROCESSING METHOD

(71) Applicant: Bank Invoice Corporation, Tokyo (JP)

(72) Inventor: Taro TESHIMA, Tokyo (JP)

(73) Assignee: Bank Invoice Corporation

(21) Appl. No.: 15/957,535

(22) Filed: Apr. 19, 2018

Related U.S. Application Data
(63) Continuation of application No. PCT/JP2016/064609, filed on May 17, 2016.

(30) Foreign Application Priority Data
Oct. 27, 2015 (JP) 2015-211151

(51) Int. Cl. G06F 17/30

(52) U.S. Cl. CPC G06F 17/30675; G06Q 10/063

(57) ABSTRACT

An invoice management apparatus has an invoice data storage unit that stores therein, when invoice data addressed to a specified recipient is received from a terminal device over a network, the received invoice data in association with the mail address of the recipient and the mail address of the issuer of the invoice data, an external communication data storage unit that stores therein external communication data associated with each invoice data, and a data processing unit that searches external communication data to find a word matching a word search request received from the terminal device and displays the contents of invoice data associated with external communication data including the matching word on a processing screen of the terminal device.

### CROSS-REFERENCE TO RELATED APPLICATION

This application is a continuation application of International Application PCT/JP2016/064609 filed on May 17, 2016, designating the U.S. and claiming priority from Japanese Patent Application No. 2015-211151 filed on Oct. 27, 2015. The entire contents of both foregoing applications are incorporated herein by reference.

### FIELD

The embodiments discussed herein relate to an information processing apparatus and an information processing method.

### BACKGROUND

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

Consider, for example, the case of receiving an inquiry about a received business document from a business client.

In a situation where a large number of business documents arrive, it is hard to find a desired business document at once. If these business documents are managed centrally, the desired business document would be found easily, which is convenient.

### SUMMARY

According to one aspect, therein provided an information processing apparatus including: a business document data storage unit that stores therein, when business document data addressed to a specified recipient is received from a terminal device over a network, the received business document data in association with identification information of the recipient and identification information of an issuer of the business document data; a text data storage unit that stores therein text data associated with each business document data; and a display unit that displays, upon receipt of a display request for the text data from the issuer or the recipient via a corresponding terminal device, the text data of the business document data associated with the identification information of the issuer or the recipient having sent the display request among the business document data stored in the business document data storage unit, and searches the displayed text data to find a word matching a word search request received via the corresponding terminal device, and displays contents of the business document data associated with text data including the matching word, on a processing screen of the corresponding terminal device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to a first embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data.

FIG. 6 is a view for explaining information to be displayed in a summary display area.

FIGS. 7A and 7B are views for explaining information to be displayed in the summary display area.

FIG. 8 is a view for explaining how to process returned invoice data.

FIG. 9 is a view for explaining an example of external communication data.

FIG. 10 is a view for explaining an example of attached file data.

FIG. 11 is a view for explaining an example of data stored in a history data storage unit.

FIG. 12 is a view for explaining an example of data stored in the history data storage unit.

FIGS. 13A and 13B are views for explaining examples of data to be displayed in an information display area in a history display mode.

FIG. 14 is a view for explaining an example of memo data.

FIG. 15 is a view for explaining an example of an external communication list.

FIG. 16 is a view for explaining an example of the external communication list.

FIG. 17 is a flowchart for explaining how a data processing unit operates to find invoice data.

FIG. 18 illustrates a management screen according to a second embodiment.

FIG. 19 is a block diagram illustrating functions of an invoice management apparatus according to the second embodiment.

FIG. 20 is a view for explaining the contents of an authority information storage unit.

### DESCRIPTION OF EMBODIMENTS

Hereinafter, an invoice management system according to embodiments will be described in detail with reference to the accompanying drawings.

### First Embodiment

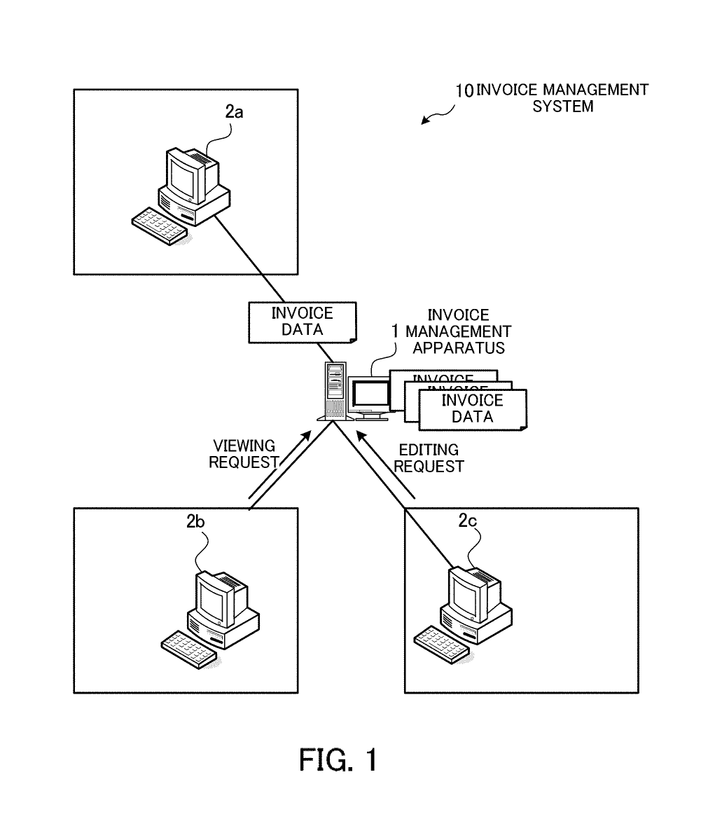

FIG. 1 illustrates an invoice management system according to a first embodiment.

In the invoice management system 10 of the first embodiment, an invoice management apparatus 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personnel computers, laptop personnel computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the present invention explains communication of invoice data, but invoices are an example of business documents and the present invention is not limited thereto. Other examples of business documents include estimate forms and order forms.

Hereinafter, it is assumed that the invoice management system 10 is used by the individual accounting persons of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting persons are able to operate their terminal devices 2a, 2b, and 2c to process invoice data, which is a digitized version of original invoices, via the invoice management apparatus 1. The processing of invoice data include creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described earlier, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

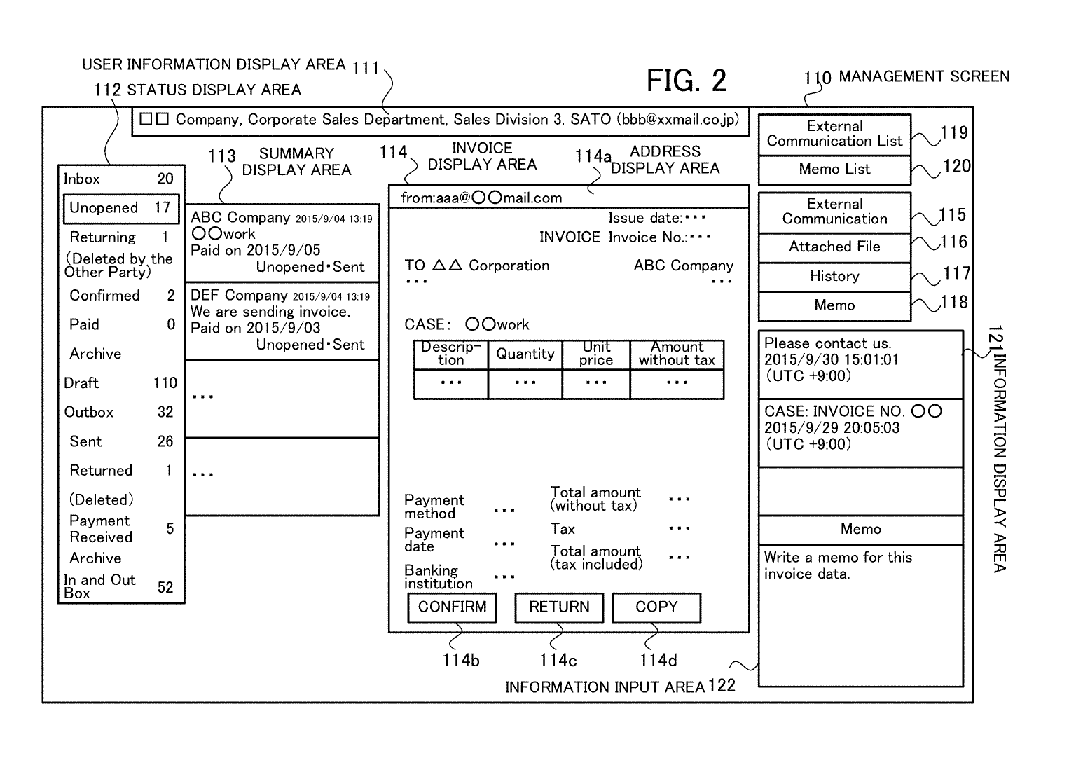

FIG. 2 is a view for explaining an example of a screen to be displayed on a terminal device after a login.

The management screen 110 illustrated in FIG. 2 is an example of a screen to be displayed on the terminal device 2a.

As illustrated in FIG. 2, an accounting personnel is able to create, issue, view, and edit invoice data, like he/she uses mail software.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

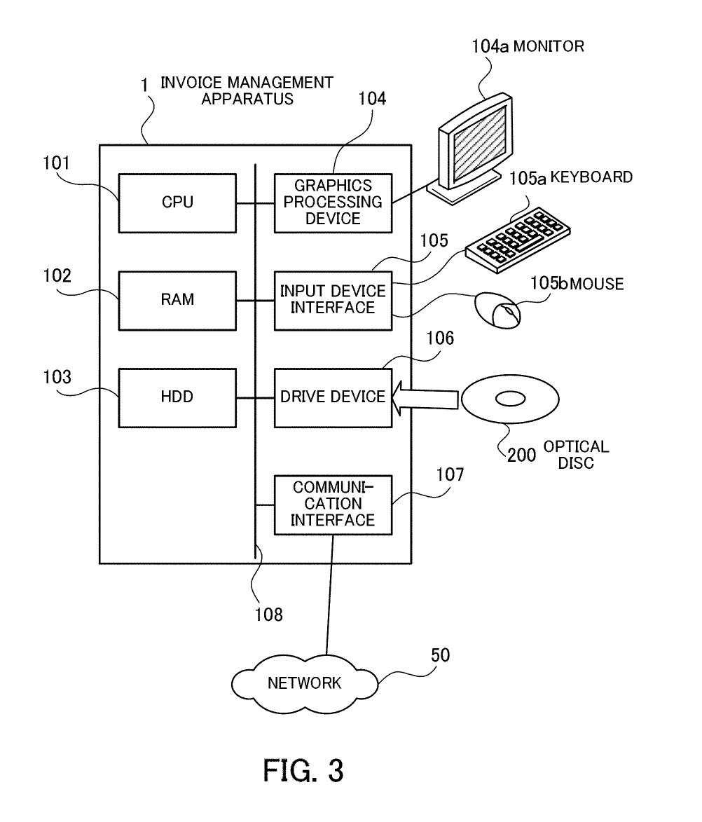

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of an OS (operating system) program and an application program that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. An OS program, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on the optical disc 200 may be read with laser light or the like. Examples of the optical disc 200 include Blu-ray (registered trademark), DVD (digital versatile disc), DVD-RAM, CD-ROM (Compact Disc Read Only Memory), CD-R (Recordable), and CD-RW (ReWritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 has the following functions.

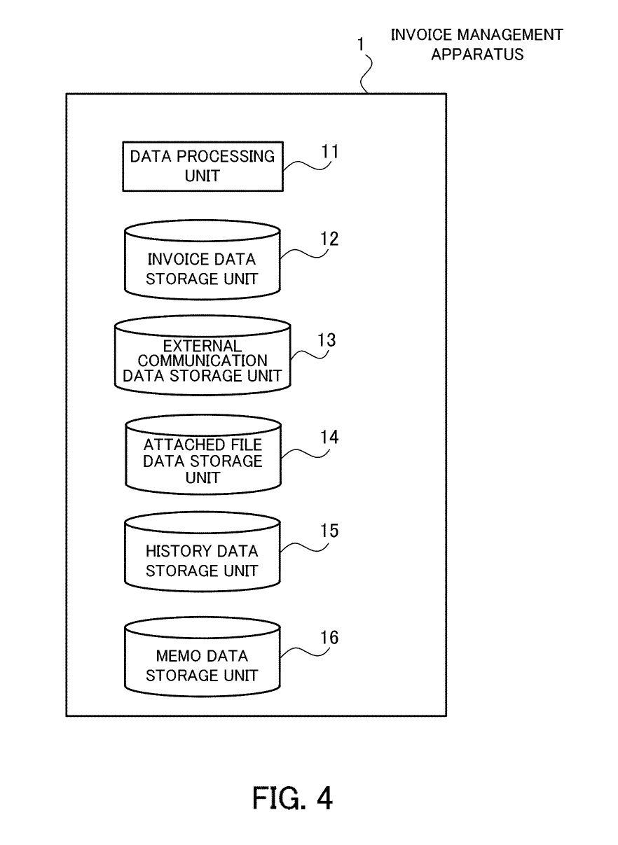

FIG. 4 is a block diagram illustrating functions of the invoice management apparatus according to the present embodiment.

The invoice management apparatus 1 has a data processing unit 11, an invoice data storage unit 12, an external communication data storage unit 13, an attached file data storage unit 14, a history data storage unit 15, and a memo data storage unit 16.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications (will be described later) and memos made by an accounting personnel, and others in appropriate storage units.

The invoice data storage unit 12 stores therein invoice data received by the invoice management apparatus 1, by accounting personnel (more specifically, by mail address of accounting personnel). The invoice data received by the invoice management apparatus 1 includes invoice data sent from accounting persons of billers to accounting persons of bill-to parties and invoice data drafted by the accounting persons (issuers) of the billers

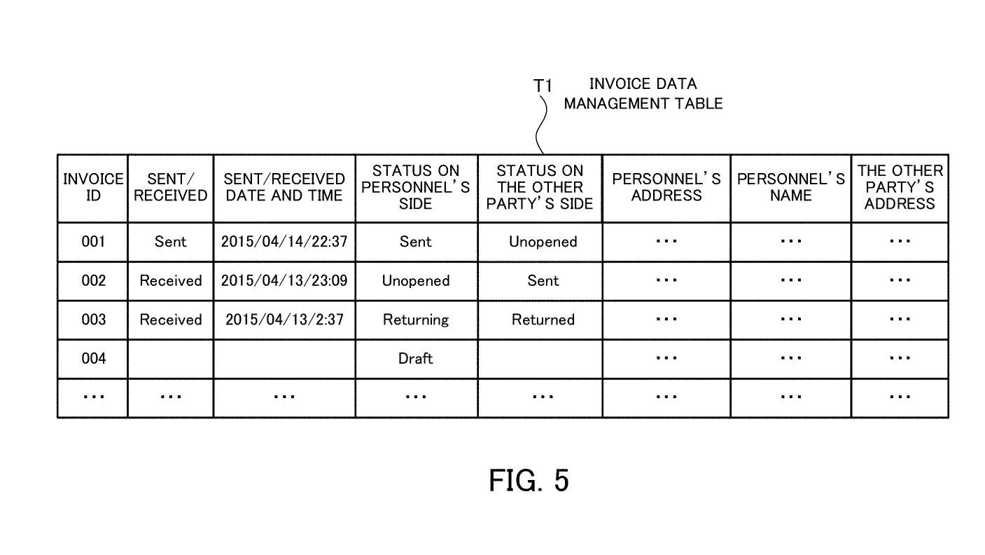

FIG. 5 is a view for explaining an example of invoice data.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Address, Personnel's Name, and The Other Party's Address. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the department to which the accounting personal belongs and the name of the accounting personnel.

The Other Party's Address column contains the mail address of the accounting personnel of the other party that communicates the invoice data.

In addition to the above-described information, the invoice data management table contains information indicated in typical invoices, including the company name of the accounting personnel, the company name of the accounting personnel of the other party that communicates the invoice data, the postal codes and addresses of both companies, departments, a total amount, and a designated account number for money transfer.

(Management Screen)

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, an External Communication button 115, an Attached File button 116, a History button 117, a Memo button 118, an External Communication List display button 119, a Memo List display button 120, an information display area 121, and an information input area 122.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the biller among the invoice data placed in the Inbox folder.

The “Deleted by the Other Party” status is given by the data processing unit 11 to invoice data that has been received, returned by the accounting personnel to the accounting personnel of the biller, and then deleted by the accounting personnel of the biller, among the invoice data placed in the Inbox folder.

The “Confirmed” status is given by the data processing unit 11 to invoice data which the accounting personnel has viewed and for which the accounting personnel has selected a Confirm button (will be described later), among the invoice data placed in the Inbox folder.

The “Paid” status is given by the data processing unit 11 to invoice data for which the accounting personnel has made payment and then selected a Payment button (not illustrated), among the invoice data placed in the Inbox folder.

The accounting personnel compiles the invoice data in the Paid status to confirm the details of the payment.

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the contents of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the biller, among the invoice data returned from the accounting personnel of the bill-to party.

The “Payment Received” status is given by the data processing unit 11 to invoice data for which the accounting personnel of the biller has confirmed payment and selected a Payment Received button (not illustrated), among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the contents of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a biller, a case name, a payment date and time, a status on the sender side, and a status on the recipient side.

The same statuses are displayed on the management screens of both the accounting personnel who has sent invoice data and the accounting personnel who has received the invoice data.

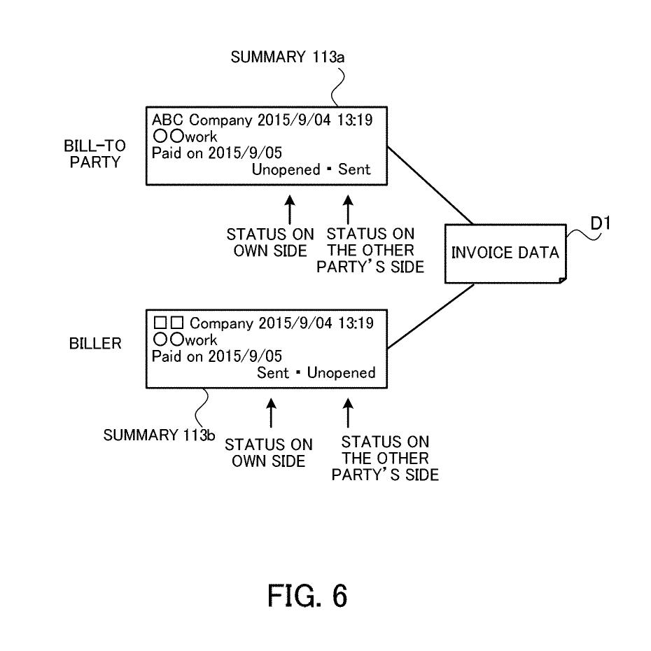

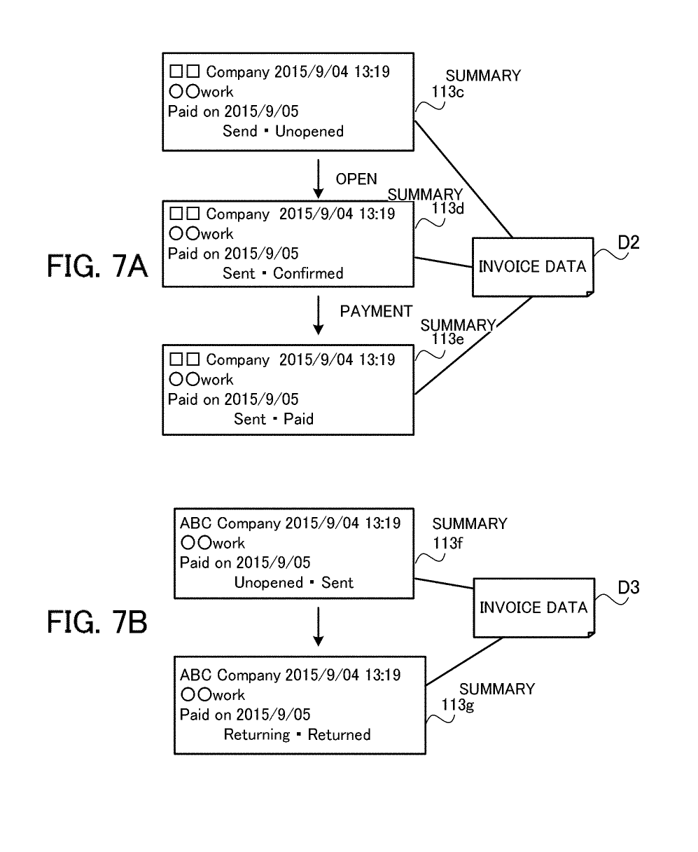

FIGS. 6, 7A, and 7B are views for explaining information to be displayed in the summary display area.

FIG. 6 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the biller.

More specifically, invoice data D1 with a biller of ABC company and a case name of ◯◯ work, as illustrated in FIG. 6, is in the “Sent” status in the status display area on the management screen of the terminal device operated by the accounting personnel of the biller. When the accounting personnel of the biller selects the “Sent” status in the status display area, the following information is displayed with respect to the invoice data D1 in the summary display area 113: a bill-to party is □□ company, a case name is ◯◯ work, a status on the accounting personnel's side of the biller is “Sent,” and a status on the accounting personnel's side of the bill-to party is “Unopened.”

By confirming status transitions, the accounting personnel of the biller is able to easily confirm the progress of processing made by the accounting personnel of the bill-to party. That is to say, the accounting persons of both parties are able to confirm the current status of each invoice data in real-time.

All summaries 113c, 113d, and 113e illustrated in FIG. 7A are of invoice data D2.

When the accounting personnel of the bill-to party has viewed the invoice data D2 and selected a Confirm button (will be described later), the data processing unit 11 changes information displayed in the summary display area 113 from the summary 113c to the summary 113d on the management screen 110 of the terminal device operated by the accounting personnel of the biller.

After that, when the accounting personnel of the bill-to party has made payment for the invoice data D2 and selected a Paid button (will be described later), the data processing unit 11 changes information displayed in the summary display area 113 from the summary 113d to the summary 113e on the management screen 110 of the terminal device operated by the accounting personnel of the biller.

As another example, both summaries 113f and 113g illustrated in FIG. 7B are of invoice data D3.

When the accounting personnel of the bill-to party has viewed the invoice data D3 and selected a Return button (will be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the contents of the invoice in the invoice display area 114. The contents of the invoice to be displayed in the invoice display area 114 are the same as those of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons to be displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned”. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the biller and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

(Returns Processing)

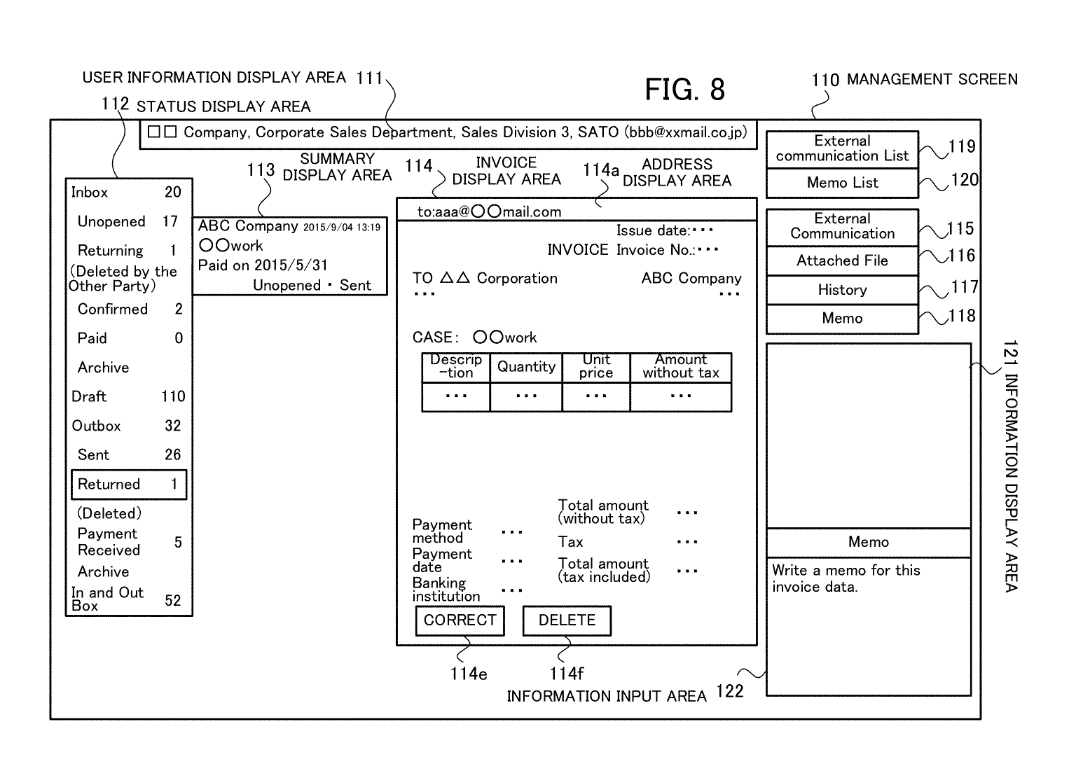

FIG. 8 is a view for explaining how to process returned invoice data.

When the accounting personnel selects the Returned status and then selects the summary of an invoice being displayed in the summary display area 113, the data processing unit 11 displays invoice data corresponding to the selected summary of the invoice in the invoice display area 114. In this case, the mail address of the accounting personnel of the bill-to party is displayed in the address display area 114a.

The invoice display area 114 includes a Correct button 114e and a Delete button 114f.

When the accounting personnel selects the Correct button 114e, the data processing unit 11 changes the status of the invoice data being displayed in the invoice display area 114 to “Deleted”. In addition, the data processing unit 11 decreases the number for the “Returned” status by one in the status display area 112, and this information is added as a history.

When the accounting personnel selects the Delete button 114f, the data processing unit 11 changes the status of the invoice data being displayed in the invoice display area 114 to “Deleted”. Thereby, the numbers for the “Outbox” folder and “Returned” status are each decreased by one in the status display area 112.

In this connection, the accounting personnel of the biller and the accounting personnel of the bill-to party are able to view invoice data even after the invoice data is deleted.

More specifically, by selecting the “Deleted” status in the status display area 112, the accounting personnel of the biller is able to view deleted invoice data. On the other hand, by selecting the “Deleted by the Other Party” status in the status display area 112, the accounting personnel of the bill-to party is able to view deleted invoice data.

Refer back to FIG. 2.

Among all invoice data placed in the Inbox and Outbox folders, data other than deleted invoice data, invoice data saved in the archive, and invoice data in the Draft status is placed in the In and Out Box folder.

(External Communication Button)

When the accounting personnel selects the External Communication button 115, the data processing unit 11 switches the management screen 110 into an external communication input mode. In this external communication input mode, when the accounting personnel enters text (text data) in the information input area 122 and presses the enter key of a keyboard or the like to fix this operation, the data processing unit 11 stores, as an external communication, the text data in the external communication data storage unit 13 in association with the mail address of the accounting personnel and the invoice data being displayed in the invoice display area 114.

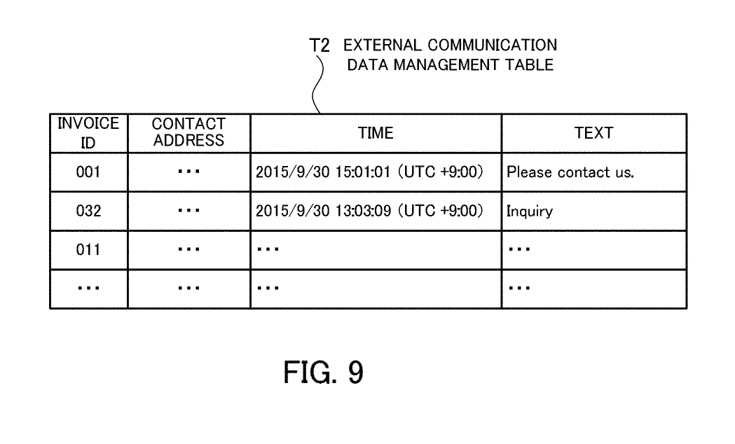

FIG. 9 is a view for explaining an example of external communication data.

In the present embodiment, external communication data is stored in tabular form.

An external communication data management table T2 has the following columns: Invoice ID, Contact Address, Time, and Text. Information pieces arranged in a horizontal direction are associated with each other.

The Invoice ID column contains the invoice ID of invoice data (invoice data associated with external communication data) that was displayed in the invoice display area 114 when the accounting personnel created the external communication data.

The Contact Address column contains the mail address of a creator that has created the external communication data.

The Time column contains the creation date and time of the external communication data.

The Text column contains the contents of the external communication.

In addition, in the external communication input mode, the data processing unit 11 refers to the external communication data management table T2 with respect to the invoice data being displayed in the invoice display area 114, and displays the external communications created so far, together with the creation dates and times in chronological order in the information display area 121.

The information display area 121 displays external communications entered by the accounting persons of both the sender and the recipient of the invoice data. Therefore, this external communication input mode enables these accounting persons to perform communications like chats with each other.

In this connection, other processing (downloading, conversion to PDF format, and others) performed by the accounting persons on the invoice data being displayed in the invoice data display area 114 may be indicated in the information display area 121 together with the execution dates and times of the processing. This enables both the accounting persons to know the history on each other's processing.

(Attached File Button)

When the accounting personnel selects the Attached File button 116, the data processing unit 11 switches the management screen 110 into an attached file mode. In this attached file mode, when the accounting personnel clicks and drags attached data into the information input area 112 and presses the enter key of the keyboard or the like to fix this operation, the data processing unit 11 stores the attached data in the attached file data storage unit 14 in association with the mail address of the accounting personnel and the invoice data being displayed in the invoice display area 114.

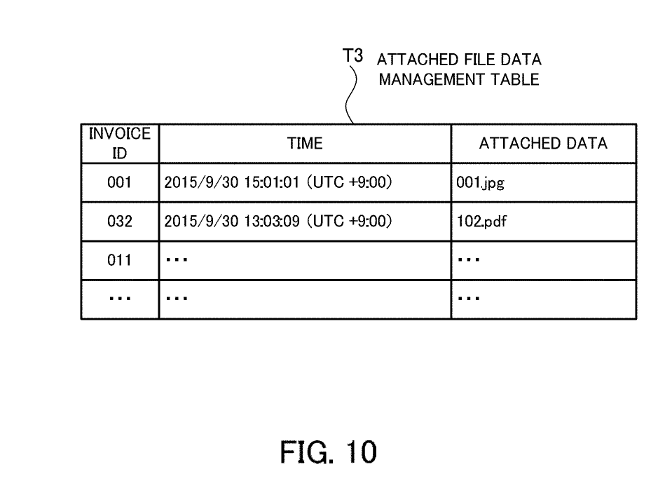

FIG. 10 is a view for explaining an example of attached file data.

In the present embodiment, attached file data is stored in tabular form.

An attached file data management table T3 has the following columns: Invoice ID, Time, and Attached Data. Information pieces arranged in a horizontal direction are associated with each other.

The Invoice ID column contains the invoice ID of invoice data (invoice data associated with attached data) that was displayed on a screen when the attached data was attached.

The Time column contains the attached date and time of the attached data.

The Attached Data column contains the name of the attached data.

In a file mode, the data processing unit 11 refers to the attached file data management table T3 with respect to invoice data being displayed in the invoice display area 114, and displays information about attached files attached so far, in chronological order in the information display area 121.

(History Button)

The data processing unit 11 stores a history on operations made so far by the accounting persons of both parties in the history data storage unit 15.

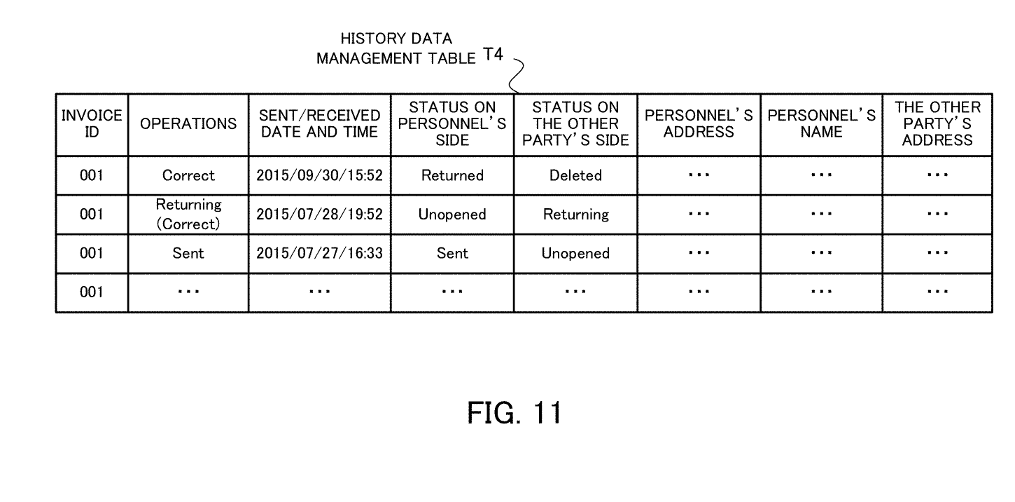

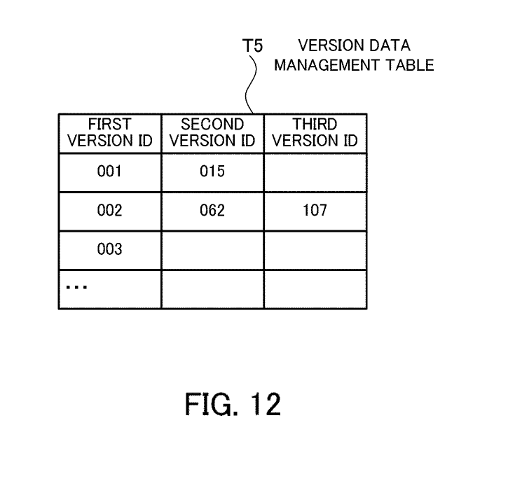

FIGS. 11 and 12 are views for explaining an example of data stored in the history data storage unit.

In the present embodiment, data is stored in tabular form.

The data processing unit 11 creates a history data management table T4 for each invoice data. In this connection, a different history data management table T4 is created for a different version.

The history data management table T4 has the following columns: Invoice ID, Operations, Send/Received Date and Time, Status on Personnel's Side, Status on the Other Party's Side, Personnel's Address, Personnel's Name, and The Other Party's Address. Information pieces arranged in a horizontal direction are associated with each other.

The Operations column contains an operation made by the accounting personnel. The other columns have the same contents as those of the invoice data management table T1, and therefore the description of these columns will not be repeated.

As illustrated in FIG. 12, a version data management table T5 has the following columns: First Version ID, Second Version ID, and Third Version ID. Information pieces arranged in a horizontal direction are associated with each other.

The First Version ID column contains an invoice ID that was given by the data processing unit 11 when the accounting personnel created invoice data and selected a Save button (not illustrated) on the management screen 110.

The Second Version ID column contains an invoice ID that was given by the data processing unit 11 when the accounting personnel created a second version based on the invoice data with the first version ID and selected the Save button (not illustrated) on the management screen 110.

The Third Version ID column contains an invoice ID that was given by the data processing unit 11 when the accounting personnel created a third version based on the invoice data with the second version ID and selected the Save button (not illustrated) on the management screen 110.

FIG. 12 illustrates columns up to the third version. If a fourth version of the invoice data is created, the data processing unit 11 adds an invoice ID of the created invoice data to a column of the version data management table T5. The same operation is performed for the fifth and subsequent versions.

When the accounting personnel selects the History button 117, the data processing unit 11 switches the management screen 110 to a history display mode. More specifically, the data processing unit 11 refers to the history data management table T4 and the version data management table T5, and displays a history about transactions of the invoice data being displayed in the invoice display area 114, in chronological order in the information display area 121.

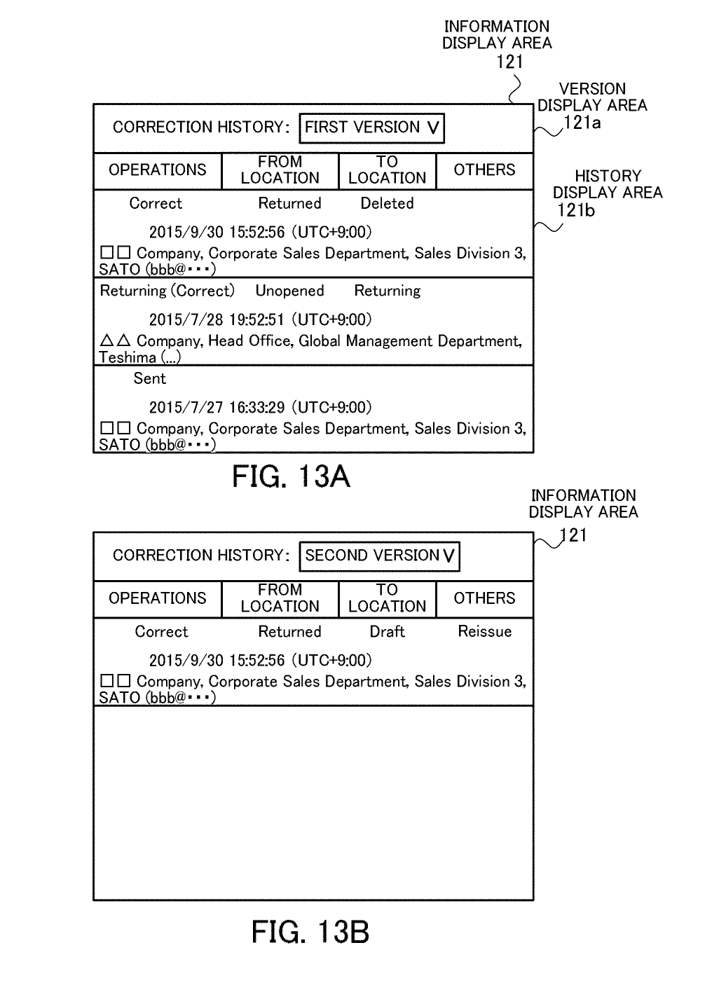

FIGS. 13A and 13B are views for explaining examples of data to be displayed in the information display area in the history display mode.

The information display area 121 has a version display area 121a for displaying a version of invoice data and a history display area 121b for displaying a history about transactions of the invoice data.

The data processing unit 11 refers to the history data management table T4 and displays transactions of invoice data in chronological order in the history display area 121b. Referring to the example of FIG. 13A, the following transactions are displayed: the invoice data being displayed in the invoice display area 114 was created and sent by SATO, who is a sender accounting personnel; the invoice data was returned by TESHIMA, who is a recipient accounting personnel; the invoice data was corrected by SATO to thereby create a second version of the invoice data; and the first version of the invoice data was deleted by SATO.

In addition, when the accounting personnel selects another version, the data processing unit 11 refers to the version data management table T5 to identify the invoice data in question. In the example of FIG. 12, for example, if the invoice ID corresponding to the first version of invoice data is “001” and the accounting personnel selects the second version of the invoice data, the data processing unit 11 identifies invoice data with an invoice ID of “015”. Then, the data processing unit 11 refers to the history data management table T4 to display transactions of the invoice data in chronological order in the history display area 121b. In the example of FIG. 13B, the following transaction is displayed: Sato is drafting a second version of the invoice data.

(Memo Button)

When the accounting personnel selects the Memo button 118, the data processing unit 11 switches the management screen 110 into a memo input mode. In this memo input mode, when the accounting personnel enters letters and so on in the information input area 122 and presses the enter key of the keyboard or the like to fix this operation, the data processing unit 11 stores the letters and so on as a memo in association with the mail address of the accounting personnel and the invoice data being displayed in the invoice display area 114 in the memo data storage unit 16. This memo is viewable only by the person who created the memo.

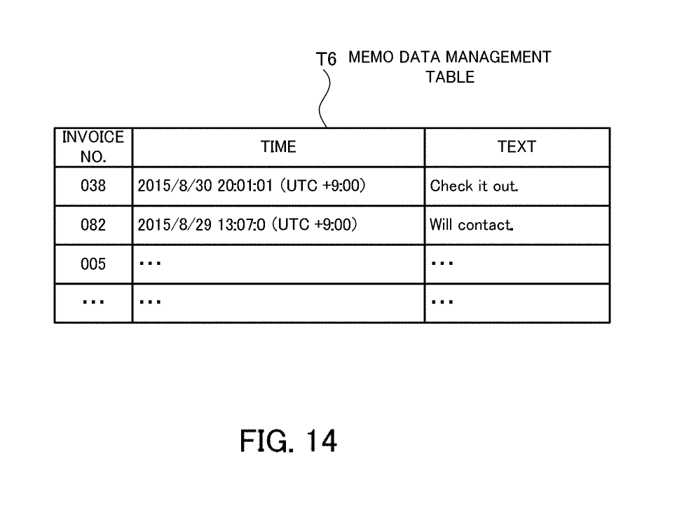

FIG. 14 is a view for explaining an example of memo data.

In the present embodiment, memo data is stored in tabular form.

A memo data management table T6 has the following columns: Invoice ID, Time, and Text. Information pieces arranged in a horizontal direction are associated with each other.

The Invoice ID column contains the invoice ID of invoice data (invoice data associated with a memo) that was displayed on a screen when the accounting personnel created the memo.

The Time column contains the creation date and time of the memo data.

The Text column contains the contents of the memo.

In addition, in the memo input mode, the data processing unit 11 refers to the memo data storage unit 16 to display memos created so far about invoice data being displayed in the invoice display area 114 in chronological order in the information display area 121.

(External Communication List Display Button)

When the accounting personnel selects the External Communication List display button 119, the data processing unit 11 refers to the external communication data storage unit 13 storing therein data about external communications, and displays a list screen (external communication list screen) regarding external communications about invoices handled by the accounting personnel in chronological order on the management screen 110.

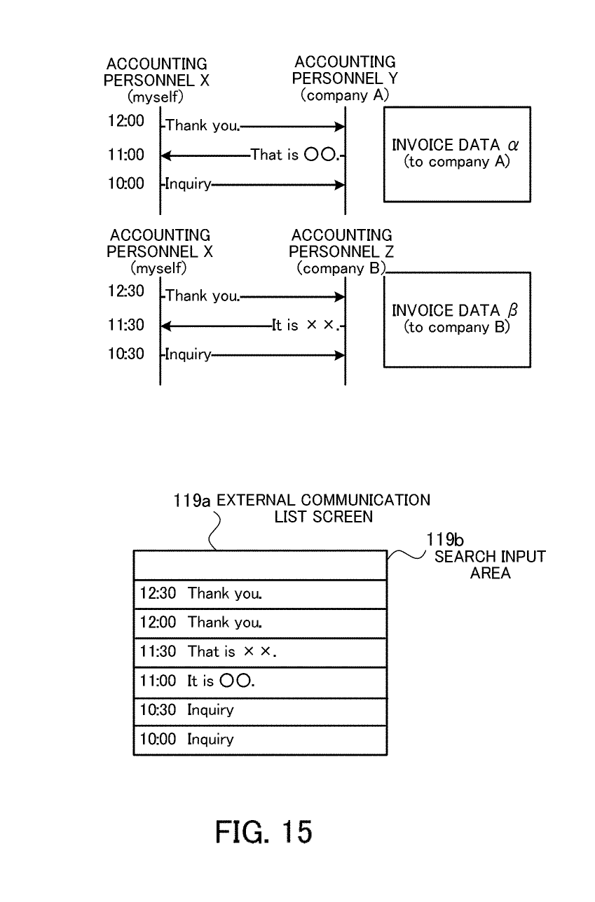

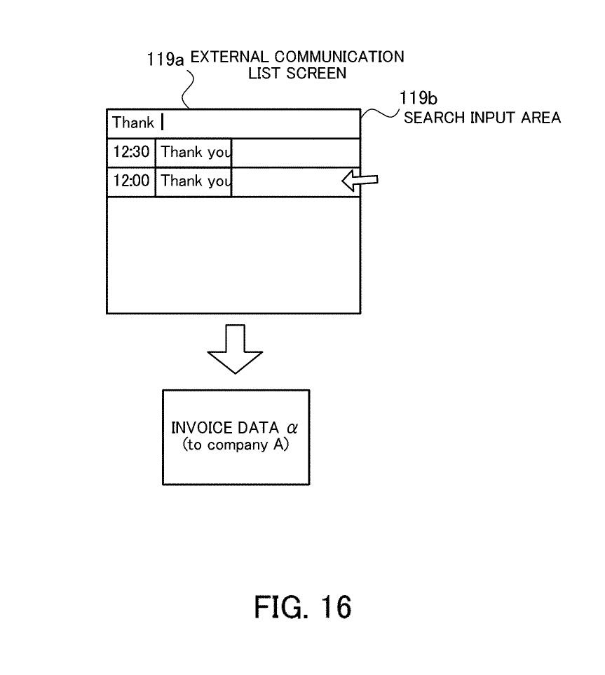

FIGS. 15 and 16 are views for explaining an example of an external communication list.

As illustrated in FIG. 15, assume that an accounting personnel X made external communications with an accounting personnel Y with regard to invoice data α at 10:00, 11:00, and 12:00 on the same day, and the accounting personnel X makes external communications with an accounting personnel Z with regard to invoice data β at 10:30, 11:30, and 12:30 on the same day.

In this case, an external communication list screen 119a as illustrated in FIG. 15 is displayed on the management screen of the terminal device operated by the accounting personnel X. This external communication list screen 119a displays a log about external communications with other accounting persons in chronological order, not for each invoice data.

This external communication list screen 119a has a search input area 119b. When the accounting personnel X enters a search word and presses an enter key (search request), the data processing unit 11 identifies external communications including a text matching the search word.

For example, as illustrated in FIG. 16, when the accounting personnel X enters “Thank you” in the search input area 119b and presses the enter key, the data processing unit 11 displays “Thank you” at 12:00 and “Thank you” at 12:30 as a search result. For example, when the accounting personnel X selects and clicks on “Thank you” at 12:00, the data processing unit 11 displays the contents of invoice data α associated with the external communication data including the text in question, in the invoice display area 114.

In this way, it is possible to easily find invoice data on the basis of terms used in external communications.

In this connection, without entering a search word in the search input area 119b, the accounting personnel may directly click on a desired text on the external communication list screen 119a. This operation also causes the data processing unit 11 to display the contents of invoice data associated with external communication data including the text in question in the invoice display area 114.

The following describes how the data processing unit operates to find invoice data.

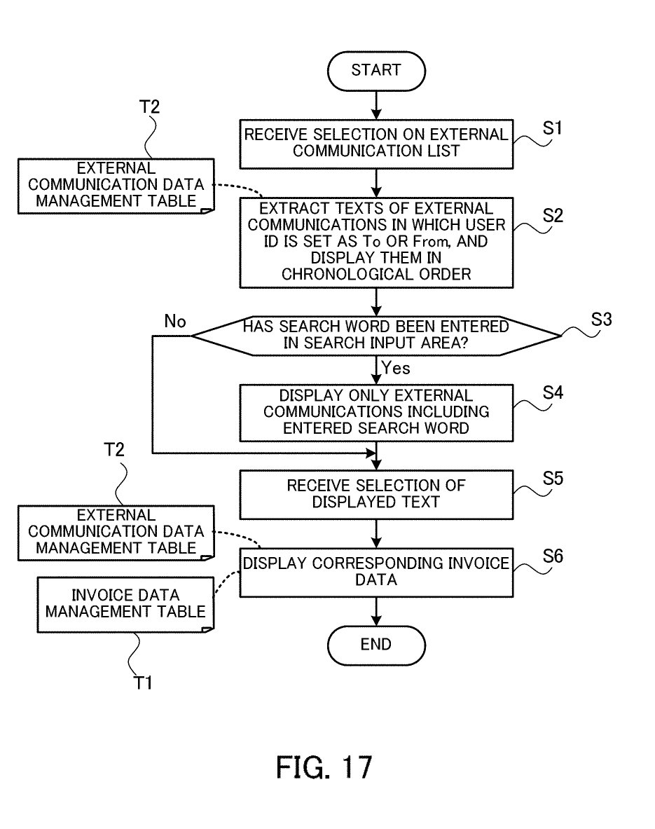

FIG. 17 is a flowchart for explaining how the data processing unit operates to find invoice data.

(Step S1) When the data processing unit 11 receives selection of the External Communication List display button 119, the process proceeds to step S2.

(Step S2) The data processing unit 11 refers to the external communication data management table T2. The data processing unit 11 extracts all external communication data with respect to an accounting person who is indicated in the user information display area 111 and whose mail address is stored in the Contact Address column. Then, the data processing unit 11 displays the texts of the extracted external communication data in chronological order in the external communication list screen 119a. Then, the process proceeds to step S3.

(Step S3) The data processing unit 11 determines whether a search word has been entered in the search input area 119b. If the search word has been entered (Yes at step S3), the process proceeds to step S4. If no search word has been entered (No at step S3), the process proceeds to step S5.

(Step S4) The data processing unit 11 displays only external communications including the entered search word in the external communication list screen 119a.

(Step S5) When the data processing unit 11 receives selection of a text being displayed, the process proceeds to step S6.

(Step S6) The data processing unit 11 refers to the external communication data management table T2, and identifies an invoice ID of external communication data including the text. The data processing unit 11 then refers to the invoice data management table T1 and displays the contents of invoice data whose invoice ID matches the identified invoice ID in the invoice display area 114.

FIG. 17 has been described.

Referring back to FIG. 2. When the accounting personnel selects the Memo List display button 120, the data processing unit 11 refers to the memo data storage unit 16 storing therein data on external communications, to display a list screen (memo list screen) of memos regarding invoices handled by the accounting personnel in chronological order on the management screen 110.

As described earlier, in the invoice management system 10, invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The information display area 121 displays external communications made by the accounting persons of both the sender and the recipient of invoice data. Therefore, using the external communication input mode enables the accounting persons of both parties to perform communications like chats.

Information on invoice data is stored in the invoice data management table T1 when the invoice data is sent, and the statuses of subsequent transactions are managed using this invoice data management table T1. Therefore, the accounting personnel is able to get away from manually compiling invoices into a data sheet.

### Second Embodiment

The following describes an invoice management system according to a second embodiment.

Hereinafter, with regard to the invoice management system of the second embodiment, differential features from the above-described first embodiment will mainly be described, and features that are the same as those of the first embodiment will not be described again.

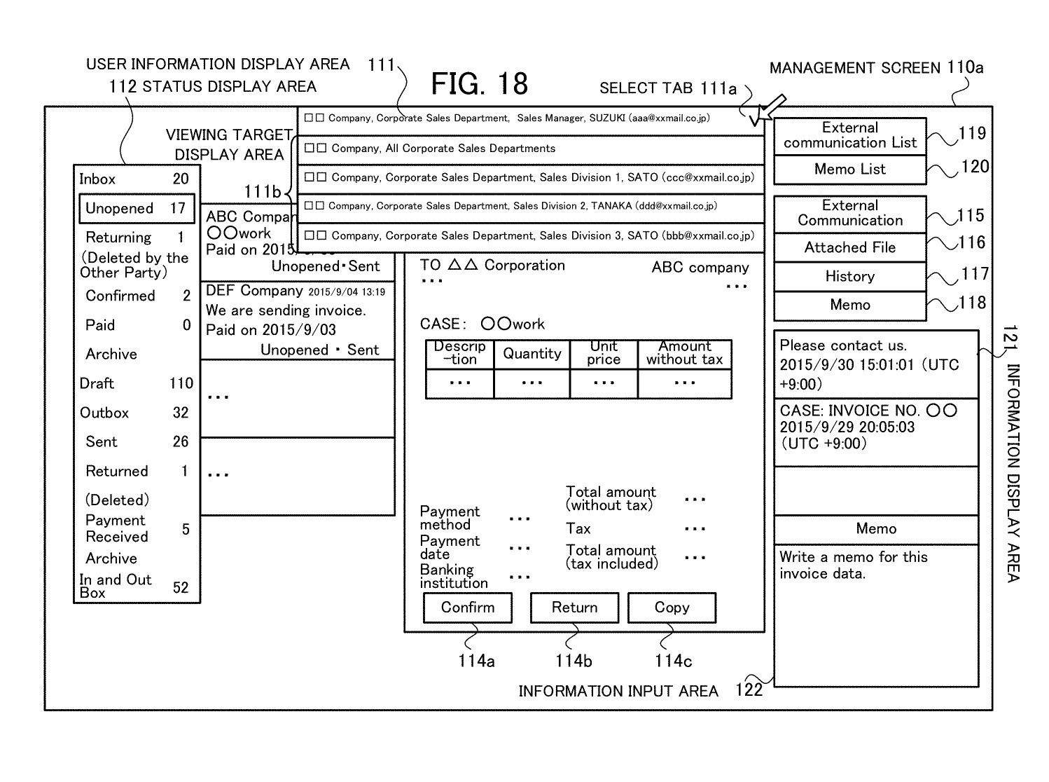

FIG. 18 illustrates a management screen according to the second embodiment.

The invoice management system of the second embodiment is different from that of the first embodiment in that a viewing authority and an editing authority are given to other users.

More specifically, as illustrated in FIG. 18, a user information display area 111 of a management screen 110a of the second embodiment displays information indicating that SUZUKI, a sales director, has logged in. The user information display area 111 has a Select tab 111a.

Assume now that SUZUKI has a viewing authority for invoice data addressed to all accounting persons of sales departments as recipients. The recipients here are not the bill-to party of the invoice data but are the mail addresses to which the invoice data is sent.

When SUZUKI selects this Select tab 111a, the data processing unit 11 displays the names, departments, and mail addresses of persons handling invoice data which SUZUKI is allowed to view, in a viewing target display area 111b.

SUZUKI selects a desired accounting personnel displayed in the viewing target display area 111b to view invoice data handled by the selected accounting personnel. For example, when SUZUKI selects SATO, the data processing unit 11 displays the same information as displayed on the management screen to be displayed when SATO logs in to the system, on the monitor connected to the terminal device.

In addition, when SUZUKI selects All Corporate Sales Departments, the data processing unit 11 displays a management screen regarding invoice data addressed to the mail addresses of all accounting persons belonging to the corporate sales departments, on the monitor connected to the terminal device.

The following describes how the invoice management apparatus of the second embodiment operates.

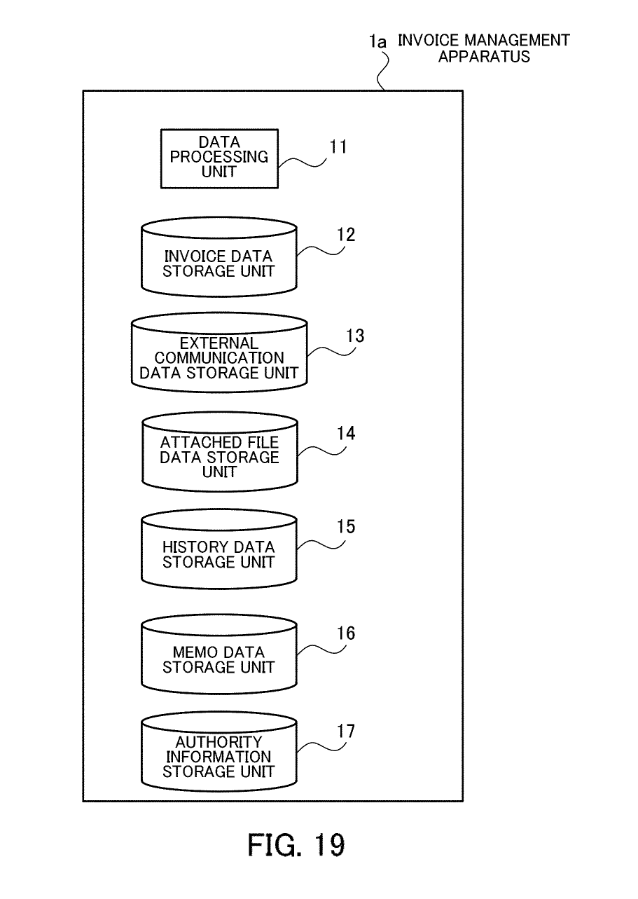

FIG. 19 is a block diagram illustrating functions of the invoice management apparatus according to the second embodiment.

The invoice management apparatus 1a of the second embodiment has an authority information storage unit 17 storing therein information on a viewing authority.

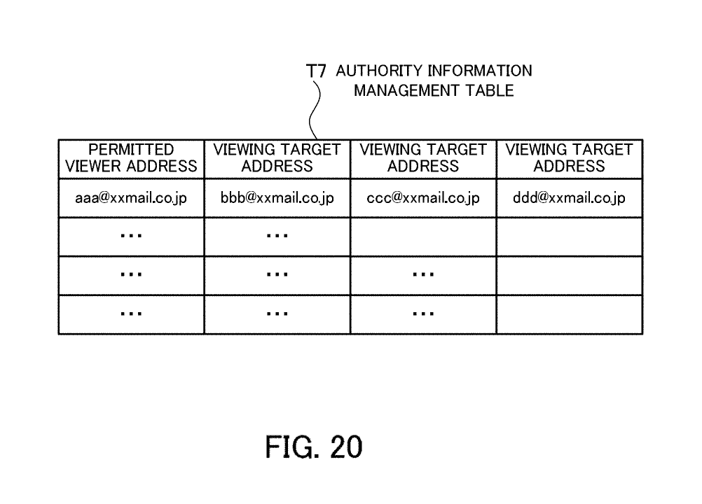

FIG. 20 is a view for explaining the contents of the authority information storage unit.

In the present embodiment, authority information is stored in tabular form.

An authority information management table T7 has the following columns: Permitted Viewer Address and Viewing Target Address. Information pieces arranged in a horizontal direction are associated with each other.

The Permitted Viewer Address column contains the mail addresses of a personnel who is able to view invoice data addressed to other persons.

The Viewing Target Address column contains the mail address of a personnel who handles invoice data to be viewed by the permitted viewer.

Referring to FIG. 20, three viewing target addresses at most are set. However, the addresses of four or more viewing targets may be set.

When the user selects the Select tab 111a, the data processing unit 11 refers to the authority information management table T7. Then, the data processing unit 11 determines whether the Permitted Viewer Address column includes a mail address matching the mail address of the user.

If the Permitted Viewer Address column includes a mail address matching the mail address of the user, the data processing unit 11 refers to the invoice data management table T1. Then, the data processing unit 11 identifies a record that has a mail address matching the mail address set in the Viewing Target Address column, in the Personnel's Address column, and extracts the department and personnel's name from the Personnel's Name column of the identified record.

The data processing unit 11 displays the extracted department and personnel's name together with the mail address in the viewing target display area 111b. Thereby, the user is able to view invoice data that is viewable by the user and is addressed to different persons. The different persons here are not the bill-to parties of the invoice data but the mail addresses of the recipients of the invoice data.

The invoice management system of the second embodiment provides the same effects as that of the first embodiment.

In addition, the invoice management system of the second embodiment enables a user to view invoice data that is viewable by the user and is addressed to other persons.

The present embodiment describes the example of giving a viewing authority. In addition to this, an editing authority for invoice data sent to other persons may be given.

Note that the processing performed by the invoice management apparatus 1 may be performed in a distributed manner by a plurality of apparatuses.

In addition, in the embodiments, the invoice management apparatus 1 is provided with various storage units including the invoice data storage unit 12. The embodiments are not limited thereto, and cloud storage may be provided, instead of the various storage units, at a location different from the data processing unit 11.

Heretofore, the information processing apparatus and information processing method of the present invention have been described in the embodiments illustrated. The invention is not limited thereto, and the components of each unit may be replaced with other components having equivalent functions or other components. In addition, other desired configurations and steps may be added.

Further, two or more desired configurations (features) in the above-described embodiments may be combined.

The above-described processing functions may be implemented by using a computer. In this case, a program is prepared, which describes processes for the functions of the invoice management apparatus 1, la. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to enable users to find desired business documents easily.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a business document data storage unit that stores therein, when business document data addressed to a specified recipient is received from a terminal device over a network, the received business document data in association with identification information of the recipient and identification information of an issuer of the business document data;
a text data storage unit that stores therein text data associated with each business document data; and
a display unit that displays, upon receipt of a display request for the text data from the issuer or the recipient via a corresponding terminal device, the text data of the business document data associated with the identification information of the issuer or the recipient having sent the display request among the business document data stored in the business document data storage unit, and
searches the displayed text data to find a word matching a word search request received via the corresponding terminal device, and displays contents of the business document data associated with text data including the matching word, on a processing screen of the corresponding terminal device.

2. The information processing apparatus according to claim 1, further comprising:
an authority granting unit that refers to the business document data storage unit upon receipt of a viewing or editing request for business document data handled by the issuer or the recipient via the corresponding terminal device, and gives a viewing or editing authority for the business document data; and
a progress management unit that manages progress of processing performed on the business document data by the issuer and the recipient of the business document data, the business document data being updated by viewing and editing.

3. The information processing apparatus according to claim 1, further comprising:
an attached data storage unit that stores therein attached data associated with said each business document data,
wherein the text data storage unit stores therein the text data associated with said each business document data, together with input date and time of the text data, and
wherein, when displaying the contents of the business document data on the processing screen of the corresponding terminal device, the display unit refers to the attached data storage unit and the text data storage unit and displays the attached data associated with the business document data displayed, in chronological order on the processing screen.

4. The information processing apparatus according to claim 1, wherein the display unit displays progress of processing performed by the issuer and the recipient of the business document data, on processing screens of terminal devices of the issuer and the recipient in real-time.

5. The information processing apparatus according to claim 1, further comprising:
an authority granting unit that refers to the business document data storage unit upon receipt of a viewing or editing request for business document data handled by the issuer or the recipient via the corresponding terminal device, and gives an editing authority for the business document data; and
a version information storage unit that stores therein, when a version number of the business document data is updated by editing the business document data, identification information of the business document data before the update and identification information of the business document data after the update in association with each other,
wherein, when displaying the contents of the business document data before or after the update on the processing screen of the corresponding terminal device, the display unit displays information for switching a version number of the business document data displayed, together with the contents of the business document data on the processing screen.

6. An information processing method causing a computer including a business document data storage unit for storing therein, when business document data addressed to a specified recipient is received from a terminal device over a network, the received business document data in association with identification information of the recipient and identification information of an issuer of the business document data, and a text data storage unit for storing therein text data associated with each business document data, to perform a process comprising:
displaying, upon receipt of a display request for the text data from the issuer or the recipient via a corresponding terminal device, the text data of the business document data associated with the identification information of the issuer or the recipient having sent the display request among the business document data stored in the business document data storage unit;
searching the displayed text data to find a word matching a word search request received via the corresponding terminal device; and
displaying contents of the business document data associated with text data including the matching word, on a processing screen of the corresponding terminal device.

7. A non-transitory computer-readable storage medium storing a computer program that causes a computer including a business document data storage unit for storing therein, when business document data addressed to a specified recipient is received from a terminal device over a network, the received business document data in association with identification information of the recipient and identification information of an issuer of the business document data, and a text data storage unit for storing therein text data associated with each business document data, to perform a process comprising:
displaying, upon receipt of a display request for the text data from the issuer or the recipient via a corresponding terminal device, the text data of the business document data associated with the identification information of the issuer or the recipient having sent the display request among the business document data stored in the business document data storage unit;
searching the displayed text data to find a word matching a word search request received via the corresponding terminal device; and
displaying contents of the business document data associated with text data including the matching word, on a processing screen of the corresponding terminal device.
